(19) United States
(12) Patent Application Publication
(10) Pub. No.: US 2004/0176939 A1
(43) Pub. Date: Sep. 9, 2004

(54) Method, system, and product for determining loop inductance of an entire integrated circuit package

(75) Inventors: Michael Werner Beattie, Austin, TX (US); Anirudh Devgan, Austin, TX (US); Byron Lee Krauter, Leander, TX (US)

Correspondence Address: IBM CORP (YA), C/O YEE & ASSOCIATES PC, P.O. BOX 802333, DALLAS, TX, 75380, US

(73) Assignee: International Business Machines Corporation, Armonk, NY

(21) Appl. No.: 10/383,857

(22) Filed: Mar. 6, 2003

(51) Int. Cl. G06F 17/50

(52) U.S. Cl. 703/14

(57) ABSTRACT

A method, system, and product are disclosed for determining an inductance of an entire integrated circuit package taken as a whole. A model is generated of the entire integrated circuit package which has a first port, a second port, and a third port. The first port of the model is coupled in parallel to an energy source and a resistor having a known resistance. The second port of the model is shorted. And, the third port of the model is opened. The package is simulated by exciting the first port utilizing the energy source and measuring a voltage at the first port in order to produce a waveform. A time constant is determined utilizing the waveform. The inductance of the entire integrated circuit package is then determined from the first port with respect to the second port using the known resistance and the time constant.

### BACKGROUND OF THE INVENTION

1. Technical Field

The present invention relates generally to the field of integrated circuit package verification, and more specifically, to a method, system, and computer program product for verifying a full integrated circuit package by efficiently determining the loop inductance of the entire integrated circuit package.

2. Description of Related Art

Integrated circuits are coupled to a substrate utilizing an integrated circuit package. The package is responsible for supplying power to the integrated circuit, and physically supplying the circuit's signals out of the chip to the substrate. In order to accomplish this, the package may be very complex. For example, it is not unusual to have 24 or more levels of wiring within the package.

The package itself can affect the performance of the integrated circuit to which it is coupled particularly as power supply currents, power densities, and operating frequencies increase. In addition, many systems utilize ASICs which use a large number of custom integrated circuit packages which require fast and comprehensive analysis framework.

When resistance is lowered, inductance becomes more important. Because packages are essentially wiring, the inductance of the package is of great importance. Therefore, it would be useful to know the total inductance of the package.

Currently, there is no approach for efficiently determining the total inductance of the entire package. Designers have manually analyzed small portions of the package to determine the inductance of the portion. However, if these small portions are combined, they may not accurately reflect the performance of the entire package.

Therefore, a need exists for a method, system, and computer program product for determining the loop inductance of an entire integrated circuit package.

### SUMMARY OF THE INVENTION

A method, system, and product are disclosed for determining an inductance of an entire integrated circuit package taken as a whole. A model is generated of the entire integrated circuit package which has a first port, a second port, and a third port. The first port of the model is coupled in parallel to an energy source and a resistor having a known resistance. The second port of the model is shorted. And, the third port of the model is opened. The package is simulated by exciting the first port utilizing the energy source and measuring a voltage at the first port in order to produce a waveform. A time constant is determined utilizing the waveform. The inductance of the entire integrated circuit package is then determined from the first port with respect to the second port using the known resistance and the time constant.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of an integrated circuit coupled to a printed circuit board utilizing an integrated circuit package in accordance with the present invention;

FIG. 2 is a schematic circuit diagram of an integrated circuit coupled to a printed circuit board utilizing an integrated circuit package in accordance with the present invention;

FIG. 3a is a block diagram of a model of an integrated circuit package having top ports coupled to a current source and resistor, bottom ports that are shorted, and decoupling capacitance ports that are opened in accordance with the present invention;

FIG. 3b is a schematic circuit diagram that depicts the model of the integrated circuit package of FIG. 3a replaced by an effective loop inductance in accordance with the present invention;

FIG. 4 depicts a high level flow chart which illustrates determining an effective loop inductance of a package in accordance with the present invention;

FIG. 5 illustrates a high level flow chart which depicts determining an effective loop inductance of a package from the top ports with respect to the bottom ports in accordance with the present invention;

FIG. 6 depicts a high level flow chart which illustrates determining an effective loop inductance of a package from the top ports with respect to the decoupling capacitance ports in accordance with the present invention; and

FIG. 7 illustrates a detailed block diagram of a data processing system in which the present invention may be implemented.

### DETAILED DESCRIPTION OF THE PREFERRED EMBODIMENT

A preferred embodiment of the present invention and its advantages are better understood by referring to the figures, like numerals being used for like and corresponding parts of the accompanying figures.

The present invention is a method, system, and computer program product for determining an inductance of an entire integrated circuit package taken as a whole. A model is generated of the entire integrated circuit package which has top ports, bottom ports, and decoupling capacitance ports. An integrated circuit is coupled to a printed circuit board utilizing the package. The integrated circuit is coupled to the bottom ports of the package, and the printed circuit board is coupled to the top ports of the package.

The loop inductance of the entire package may be determined utilizing an extracted model of the package by simulating this model to produce a waveform. A time constant may be determined from the waveform. The effective loop inductance of the entire package may then be determined utilizing this time constant.

For example, the loop inductance of the entire package may be determined from the top ports with respect to the bottom ports. The top ports may be coupled to a resistor having a known resistance, R, and an energy source, such as a current source, in parallel. The bottom ports are then shorted, and the decoupling capacitance ports are opened. The package is simulated by exciting the top ports of the model utilizing the current source and measuring a voltage at the top ports in order to produce a waveform. A time constant is then determined utilizing the waveform. The inductance, L, of the entire integrated circuit package is then determined from the top ports with respect to the bottom ports using the formula:

L=(R)(time constant).

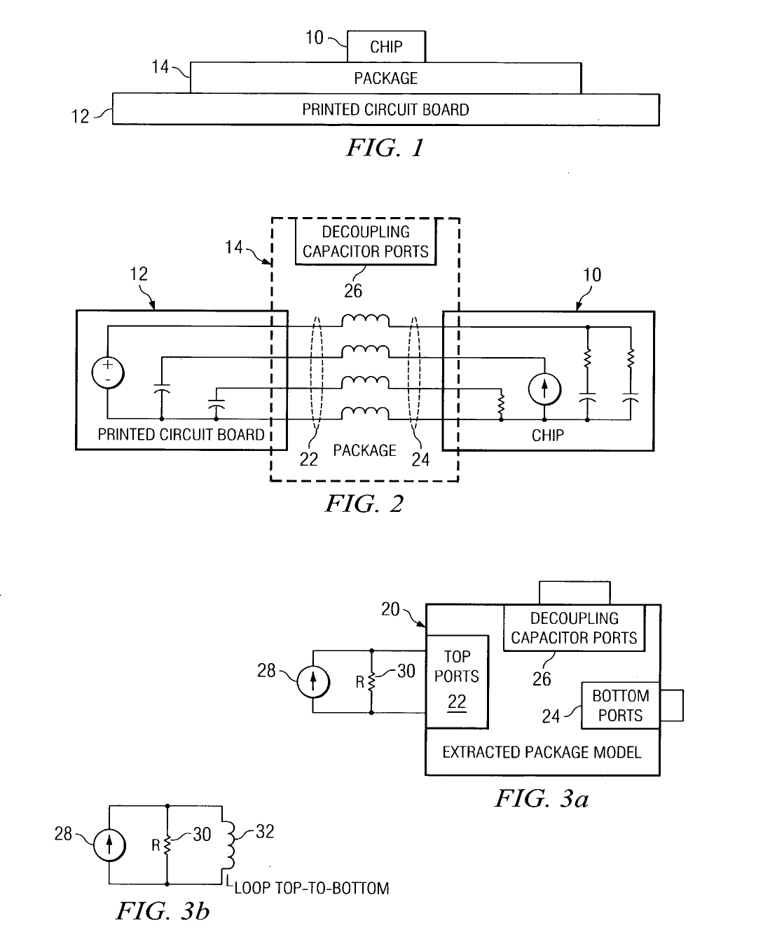

FIG. 1 is a block diagram of an integrated circuit 10, also called a chip, coupled to a printed circuit board 12, also called a substrate, utilizing an integrated circuit package 14 in accordance with the present invention.

FIG. 2 is a schematic circuit diagram of an integrated circuit 10 coupled to a printed circuit board 12 utilizing an integrated circuit package 14 in accordance with the present invention. Package 14 is coupled to a printed circuit board 12 utilizing top ports 22, and coupled to a chip 10 utilizing bottom ports 24. Decoupling capacitors (not shown) may also be coupled to package 14 utilizing decoupling capacitance ports 26 in order to minimize noise.

FIG. 3a is a block diagram of a model 20 of an integrated circuit package 14 having top ports 22 coupled to a current source 28 and resistor 30, bottom ports 24 that are shorted, and decoupling capacitance ports 26 that are opened in accordance with the present invention. Package 14 has been modeled utilizing known extraction techniques. In accordance with the present invention, the inductance of package 14 from top ports 22 with respect to bottom ports 24 can be determined by exciting top ports 22, such as by coupling top ports 22 to a current source 28 and resistor 30, shorting bottom ports 24, and opening decoupling capacitor ports 26. The voltage at top ports 22 can then be measured in order to produce a waveform. A time constant, τ, can then be computed using the waveform. The loop inductance, L, of the entire package 14 can be determined utilizing the time constant and resistance, R, utilizing the formula:

L=τR.

FIG. 3b is a schematic circuit diagram that depicts the model of the integrated circuit package of FIG. 3a replaced by an effective loop inductance in accordance with the present invention. Extracted package model 20 has been replaced by the loop inductance 32.

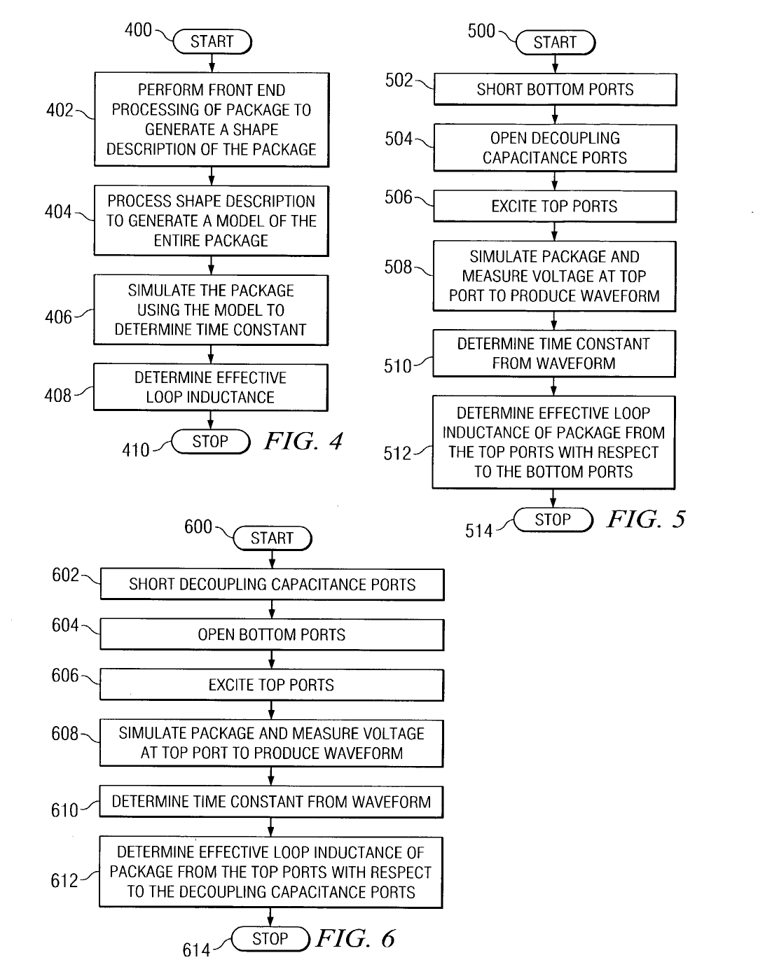

FIG. 4 depicts a high level flow chart which illustrates determining an effective loop inductance of a package in accordance with the present invention. The process starts as depicted by block 400 and thereafter passes to block 402 which illustrates performing front end processing of the package to generate a shape description of the package. This step may be performed utilizing an existing shapes processing engine such as Allegro, available from Cadence Design System, San Jose, Calif. Next, block 404 depicts processing the shape description to generate a model of the entire package. This model may be generated using known extraction techniques. Block 406, then, illustrates simulating the package using the model to determine a time constant. Thereafter, block 408 depicts determining an effective loop inductance of the package utilizing the time constant. The process then terminates as illustrated by block 410.

FIG. 5 illustrates a high level flow chart which depicts determining an effective loop inductance of a package from the top ports with respect to the bottom ports in accordance with the present invention. The process starts as illustrated by block 500 and thereafter passes to block 502 which depicts shorting the bottom ports. Next, block 504 illustrates opening the decoupling capacitance ports. Block 506, then, depicts exciting the top ports using an energy source that is coupled to the top ports. A resistor having a known resistance, R, is coupled in parallel with the energy source to the top ports. Thereafter, block 508 illustrates simulating the package and measuring the voltage at the top port in order to produce a waveform.

The process then passes to block 510 which depicts determining a time constant, τ, from the waveform. Next, block 512 illustrates determining the effective loop inductance of the package from the top ports with respect to the bottom ports utilizing the time constant and the known resistance. The process then terminates as depicted by block 514.

FIG. 6 depicts a high level flow chart which illustrates determining an effective loop inductance of a package from the top ports with respect to the decoupling capacitance ports in accordance with the present invention. The process starts as illustrated by block 600 and thereafter passes to block 602 which depicts shorting the decoupling capacitance ports. Next, block 604 illustrates opening the bottom ports. Block 606, then, depicts exciting the top ports using an energy source coupled to the top ports. A resistor having a known resistance, R, is also coupled to the top ports in parallel with the energy source. Thereafter, block 608 illustrates simulating the package and measuring the voltage at the top port in order to produce a waveform.

The process then passes to block 610 which depicts determining a time constant, τ, from the waveform. Next, block 612 illustrates determining the effective loop inductance of the package from the top ports with respect to the decoupling capacitance ports utilizing the time constant and the known resistance. The process then terminates as depicted by block 614.

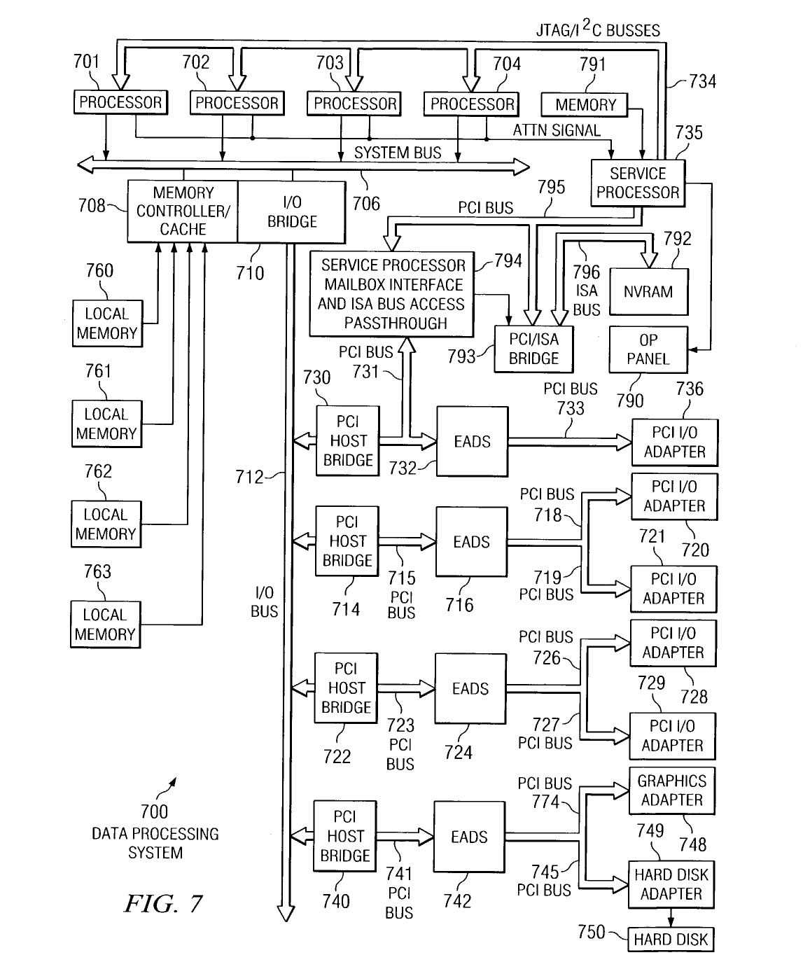

FIG. 7 illustrates a detailed block diagram of a data processing system in which the present invention may be implemented. Data processing system 700 may be a symmetric multiprocessor (SMP) system including a plurality of processors 701, 702, 703, and 704 connected to system bus 706. For example, data processing system 700 may be an IBM RS/6000, a product of International Business Machines Corporation in Armonk, N.Y., implemented as a server within a network. Alternatively, a single processor system may be employed. Also connected to system bus 706 is memory controller/cache 708, which provides an interface to a plurality of local memories 760-763. I/O bus bridge 710 is connected to system bus 706 and provides an interface to I/O bus 712. Memory controller/cache 708 and I/O bus bridge 710 may be integrated as depicted.

Data processing system 700 may be a logically partitioned data processing system. Thus, data processing system 700 may have multiple heterogeneous operating systems (or multiple instances of a single operating system) running simultaneously. Each of these multiple operating systems may have any number of software programs executing within it. Data processing system 700 is logically partitioned such that different I/O adapters 720-721, 728-729, 736, and 748-749 may be assigned to different logical partitions.

Peripheral component interconnect (PCI) Host bridge 714 connected to I/O bus 712 provides an interface to PCI local bus 715. A number of Input/Output adapters 720-721 may be connected to PCI bus 715. Typical PCI bus implementations will support between four and eight I/O adapters (i.e. expansion slots for add-in connectors). Each I/O Adapter 720-721 provides an interface between data processing system 700 and input/output devices such as, for example, other network computers, which are clients to data processing system 700.

An additional PCI host bridge 722 provides an interface for an additional PCI bus 723. PCI bus 723 is connected to a plurality of PCI I/O adapters 728-729 by a PCI bus 726-727. Thus, additional I/O devices, such as, for example, modems or network adapters may be supported through each of PCI I/O adapters 728-729. In this manner, data processing system 700 allows connections to multiple network computers.

A memory mapped graphics adapter 748 may be connected to I/O bus 712 through PCI Host Bridge 740 and EADS 742 (PCI-PCI bridge) via PCI buses 744 and 745 as depicted. Also, a hard disk 750 may also be connected to I/O bus 712 through PCI Host Bridge 740 and EADS 742 via PCI buses 741 and 745 as depicted.

A PCI host bridge 730 provides an interface for a PCI bus 731 to connect to I/O bus 712. PCI bus 731 connects PCI host bridge 730 to the service processor mailbox interface and ISA bus access pass-through logic 794 and EADS 732. The ISA bus access pass-through logic 794 forwards PCI accesses destined to the PCI/ISA bridge 793. The NVRAM storage is connected to the ISA bus 796. The Service processor 735 is coupled to the service processor mailbox interface 794 through its local PCI bus 795. Service processor 735 is also connected to processors 701-704 via a plurality of JTAG/I²C buses 734. JTAG/I²C buses 734 are a combination of JTAG/scan busses (see IEEE 1149.1) and Phillips I²C busses. However, alternatively, JTAG/I²C buses 734 may be replaced by only Phillips I²C busses or only JTAG/scan busses. All SP-ATTN signals of the host processors 701, 702, 703, and 704 are connected together to an interrupt input signal of the service processor. The service processor 735 has its own local memory 791, and has access to the hardware op-panel 790.

When data processing system 700 is initially powered up, service processor 735 uses the JTAG/scan buses 734 to interrogate the system (Host) processors 701-704, memory controller 708, and I/O bridge 710. At completion of this step, service processor 735 has an inventory and topology understanding of data processing system 700. Service processor 735 also executes Built-In-Self-Tests (BISTs), Basic Assurance Tests (BATs), and memory tests on all elements found by interrogating the system processors 701-704, memory controller 708, and I/O bridge 710. Any error information for failures detected during the BISTs, BATs, and memory tests are gathered and reported by service processor 735.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for determining an inductance of an entire integrated circuit package, said method comprising the steps of:
generating a model of said entire integrated circuit package having a first port and a second port;
coupling said first port to an energy source and a resistor having a resistance;
shorting said second port;
simulating said package by exciting said first port of said model utilizing said energy source and measuring a voltage at said first port in order to produce a waveform;
determining a time constant utilizing said waveform; and
determining an inductance of said entire integrated circuit package from said first port with respect to said second port utilizing said resistance and said time constant.

2. The method according to claim 1, further comprising the step of:
coupling said first port to an energy source and a resistor, wherein said first port is utilized to coupled said package to a substrate.

3. The method according to claim 1, further comprising the step of:
shorting said second port, wherein said second port is utilized to couple said package to an integrated circuit.

4. The method according to claim 1, further comprising the step of:
said package including a third port; and
opening said third port.

5. The method according to claim 4, further comprising the step of:
opening said third port, said third port being utilized to couple said package to decoupling capacitors.

6. The method according to claim 4, further comprising the step of:
opening said third port, said third port being utilized to couple said package to an integrated circuit.

7. The method according to claim 1, further comprising the steps of:
shorting said second port, wherein said second port is utilized to couple said package to decoupling capacitors.

8. The method according to claim 1, further comprising the steps of:
said package including a third port;
opening said third port;
coupling said first port to an energy source and a resistor, wherein said first port is utilized to coupled said package to a substrate; and
shorting said second port, wherein said second port is utilized to couple said package to an integrated circuit.

9. A method for determining an inductance of an entire integrated circuit package, said method comprising the steps of:
generating a shapes description of said entire integrated circuit package;
generating an extracted model of said entire integrated circuit package utilizing said shapes description;
simulating said extracted model to product a waveform;
determining a time constant utilizing said waveform; and
determining an inductance of said entire package utilizing said time constant.

10. A system for determining an inductance of an entire integrated circuit package, said system comprising:
generating means for generating a model of said entire integrated circuit package having a first port and a second port;
said first port being coupled to an energy source and a resistor;
said second port being shorted;
simulating means for simulating said package by exciting said first port of said model utilizing said energy source and measuring a voltage at said first port in order to produce a waveform;
determining means for determining a time constant utilizing said waveform; and
determining means for determining an inductance of said entire integrated circuit package from said first port with respect to said second port utilizing said resistance and said time constant.

11. The system according to claim 10, further comprising:
said first port being utilized for coupling said package to a substrate.

12. The system according to claim 10, further comprising:
said second port being utilized for coupling said package to an integrated circuit.

13. The system according to claim 10, further comprising;
said package including a third port; and
said third port being opened.

14. The system according to claim 13, further comprising:
said third port being utilized to couple said package to decoupling capacitors.

15. The system according to claim 13, further comprising:
said third port being utilized to couple said package to an integrated circuit.

16. The system according to claim 10, further comprising:
said second port being utilized to couple said package to decoupling capacitors.

17. The system according to claim 10, further comprising:
said package including a third port;
said third port being opened;
said first port being coupled to an energy source and a resistor, wherein said first port is utilized to coupled said package to a substrate; and
said second port being shorted, wherein said second port is utilized to couple said package to an integrated circuit.

18. A computer program product for determining an inductance of an entire integrated circuit package, said product comprising:
instruction means for generating a model of said entire integrated circuit package having a first port and a second port;
said first port being coupled to an energy source and a resistor;
said second port being shorted;
instruction means for simulating said package by exciting said first port of said model utilizing said energy source and measuring a voltage at said first port in order to produce a waveform;
instruction means for determining a time constant utilizing said waveform; and
instruction means for determining an inductance of said entire integrated circuit package from said first port with respect to said second port utilizing said resistance and said time constant.

19. The product according to claim 18, further comprising:
said first port being utilized to coupled said package to a substrate.

20. The product according to claim 18, further comprising:
said second port being utilized to couple said package to an integrated circuit.
